(19) United States
(12) Patent Application Publication
(10) Pub. No.: US 2018/0139112 A1
(43) Pub. Date: May 17, 2018

(54) DYNAMIC PERFORMANCE DETECTION IN A DISTRIBUTED COMMUNICATION SYSTEM

(71) Applicants: Robert Davis, San Mateo, CA (US); Nitin Kumar, San Ramon, CA (US); Justin George, Fremont, CA (US)

(72) Inventors: Robert Davis, San Mateo, CA (US); Nitin Kumar, San Ramon, CA (US); Justin George, Fremont, CA (US)

(21) Appl. No.: 15/813,521

(22) Filed: Nov. 15, 2017

Related U.S. Application Data
(60) Provisional application No. 62/422,530, filed on Nov. 15, 2016.

(51) Int. Cl. H04L 12/26

(52) U.S. Cl. CPC H04L 43/062; H04L 43/08; H04L 43/067

(57) ABSTRACT

A system and method for dynamically obtaining data associated with a performance metric associated with access devices associated with a resource provider in a specific geographic location and comparing it to data associated with the performance of other access devices associated with another resource provider is disclosed. A processing server computer can perform the comparison and may provide the comparison to a user device, so that corrective action, if any, may be taken.

### CROSS-REFERENCE TO RELATED APPLICATIONS

This application is a non-provisional application of U.S. Patent Application No. 62/422,530, filed on Nov. 15, 2016, which is herein incorporated by reference in its entirety for all purposes.

### BACKGROUND

Conventionally, interactions by different devices in different locations are monitored for performance and/or activity. For example, the consumption or processing of electricity, electronic content (e.g., television shows), and other resources by distributed access devices, and purchase transactions conducted using distributed access devices have been monitored by central computer systems. The central computer systems can take certain actions based upon any data coming from those locations. For example, if the consumption of electronic content such as videos in a particular locale is high relative to historical consumption in that locale, then certain preventative actions can be taken to investigate why the consumption of electronic content is higher than normal. In another example, a resource provider such as a merchant may see the sales activity associated with its access devices at a particular location sharply increased relative to historical baseline activity. However, in these cases, it is difficult to determine if the increase is due to the performance, systems, or operation of the resource provider or if there is some other underlying cause for the change.

Embodiments of the invention address these and other problems, individually and collectively.

### SUMMARY

Embodiments of the invention provide for the ability to monitor interactions of access devices of a resource provider at various locations, and compare them to access interactions of access devices of other resource providers within a similar segment. Such information can assist a particular resource provider to determine if a particular change in activity is expected or not expected. Corrective action can be taken in response to the determination.

One embodiment of the invention is directed to a method comprising: receiving, by a processing server computer, from a plurality of access devices, data relating to a plurality of interactions; determining, by the processing server computer, a location and a resource provider linked to each interaction; determining, by the processing server computer, a segment associated with each resource provider linked to each interaction; receiving, by the processing server computer, from a user device operated by a user, a request for an indication of a performance metric for a specific resource provider associated with a specific segment according to one or more specified parameters comprising a specified geographical area; comparing, by the processing server computer, based on the one or more specified parameters, interaction data for interactions linked to the specific resource provider associated with the specific segment to interaction data for other interactions linked to one or more other resource providers associated with the specific segment to form a comparison; and providing, by the processing server computer, data relating to the comparison to the user device, wherein the user is able to adjust the specified parameters using a user interface of the user device.

Another embodiment of the invention is directed to a computer comprising: a processor; and a computer readable medium. The computer readable medium comprises code, executable by the processor, for implementing a method comprising: receiving from a plurality of access devices, data relating to a plurality of interactions, determining a location and a resource provider linked to each interaction, determining a segment associated with each resource provider linked to each interaction, receiving from a user device operated by a user, a request for an indication of a performance metric for a specific resource provider associated with a specific segment according to one or more specified parameters comprising a specified geographical area, comparing based on the one or more specified parameters, interaction data for interactions linked to the specific resource provider associated with the specific segment to interaction data for other interactions linked to one or more other resource providers associated with the specific segment to form a comparison, and providing, by the processing server computer, data relating to the comparison to the user device, wherein the user is able to adjust the specified parameters using a user interface of the user device.

Another embodiment of the invention is directed to a method performed by a user device, the method comprising: providing, by a user device, a request to a processing server computer, for an indication of a performance metric for a specific resource provider associated with a specific segment according to one or more specified parameters comprising a specified geographical area, wherein the processing server computer compares, based on the specified parameters, interaction data for interactions linked to the specific resource provider associated with the specific segment to interaction data for other interactions linked to one or more other resource providers associated with the specific segment to form a comparison, and provides data relating to the comparison to the user device; and receiving, by the user device, the data relating to the comparison, wherein the user is able to adjust the one or more specified parameters using a user interface of the user device.

Another embodiment of the invention is directed to a user device programmed to perform the above-noted method.

These and other embodiments of the invention can be described in further detail below.

### BRIEF DESCRIPTION OF THE DRAWINGS

FIG. 1 shows a block diagram of a system according to embodiments of the invention.

FIG. 2 shows a block diagram illustrating a processing server computer according to embodiments of the invention.

FIG. 3 shows an example of a user interface according to an embodiment of the invention.

FIG. 4 illustrates an adjustment of a specified parameter according to an embodiment of the invention.

FIG. 5 illustrates a change in performance metric type according to an embodiment of the invention.

FIG. 6 shows an example of a performance metrics overview according to an embodiment of the invention.

FIG. 7 shows an example of indexed metrics according to an embodiment of the invention.

FIG. 8 shows an example of performance metrics calculated over time according to embodiments of the invention.

FIG. 9 shows a flowchart illustrating a method according to embodiments of the invention.

FIG. 10 shows a system diagram according to another embodiment of the invention.

### DETAILED DESCRIPTION

Embodiments of the invention are directed to methods and systems for dynamically assessing performance according to activities associated with access devices within a geographical area. According to embodiments of the invention, a processing server computer may gather interaction data such as transaction data and generate data relating to a comparison that allows a resource provider to determine performance associated with its remotely located access devices with the performance associated with other remotely located access devices for one or more other resource providers in a similar locale and within a similar segment.

In one example, the access devices may be set top boxes provided by a first content provider (e.g., a first cable TV company) in a particular locale. The amount of a particular type of content provided by those set top boxes may be compared with the amount of the particular type of content provided by another set of set top boxes provided by a second content provider (e.g., a second cable TV company) within that same locale. Using embodiments of the invention, the first content provider may determine, in a dynamic manner, the amount or type of content being processed by its set top boxes relative to the amount or type of content being processed by other set top boxes of other another content provider operating in the same locale. In this way, the first content provider can determine if changes in usage are expected or unexpected. For example, if the amount or type of content processed by its set top boxes decreases substantially, relative to its historical trend, then it can determine if the performance of its set top boxes is similar to the second content provider's set top boxes. This can indicate to the first content provider that the sudden decrease in the operation of its set top boxes is not out of the ordinary for the particular locale, and is not likely attributable to the specific actions of the first content provider. For instance, a power disruption within the locale may cause a sudden decrease in the amount of content processed by all set top boxes from all content providers, and such an event may be beyond the control of the first content provider. Conversely, if the first content provider determines that activity associated with its access devices decreased substantially, and the activity associated with the access devices of another content provider has not, then the first content provider may determine that it needs to take corrective action with respect to its access devices. Thus, embodiments of the invention provide for a way for resource providers to accurately determine if action needs to be taken in response to changes in the use of resources.

In another example, a first resource provider such as a first merchant may determine their market share in relation to a specified metropolitan statistical area (MSA) and/or zip code. Market share may be indicated by metrics within a given radius centered around a specific zip code such as share of total spend/transactions, share of cards, and spend/transactions per card, average ticket size, and/or indexed metrics. Using embodiments of the invention, resource providers may also determine market share performance over a period of time using such metrics as percentage point change vs. percentage change. Using embodiments of the invention, resource providers may also filter market share for a specific store or for all of their stores by toggling the visualization results by store market share and client market share respectively. Resource providers may also look at trends as well as identify potential location-specific opportunities using embodiments of the invention.

Prior to discussing the details of some embodiments of the present invention, description of some terms may be helpful in understanding the various embodiments.

A “user device” may comprise a device that may be used by a user. A user device may comprise elements such as a display, a processor, a memory, an input device, and a network interface. Examples of a user device may include mobile devices, personal computing devices (e.g. desktop computers, laptop computers, tablets, etc.), or any suitable device.

A “mobile device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, wearable devices (e.g., watches, glasses, lenses, tattoos, clothing, etc.), vehicles (e.g., cars), etc.

A “segment” may be a part of something that is divided. A merchant segment may include a specific category of merchant, such as restaurants, home improvement, banks, etc. A data type segment may include different types of data including movies, music, books, etc.

An “interaction” may refer to a reciprocal action or influence. A transaction between two parties, such as between a consumer and a merchant may be an example of an interaction. Other interactions may include users' use of specific data or content within certain locales.

A “parameter” may include a quantity of a value that is selected according to a particular circumstance. In some embodiments, an example of a parameter may be a selection of a particular locale or location such as a particular MSA or zip code.

A “performance metric” may be a measurement of some action or task. A performance metric may include data relating to a performance of one or more access devices, or by an entity associated with the one or more access devices. Examples may include total spend and/or transactions, share of cards, and spend and/or transactions per card, average ticket size, and/or indexed metrics. Other examples in include amount of data processed or consumed, or processing speed.

A “portable device” may be a device that is portable. A portable device may, for example, be used to conduct a transaction. A portable device may include a storage technology (e.g., electronic memory, magnetic stripe, etc.) to store credentials or tokens associated with an account of a user. A portable device can be in any of the forms described above with respect to the mobile device, or in the form of a card (e.g., integrated chip card, magnetic stripe card) or a fob, etc. In some embodiments, the portable device and the mobile device may be the same device, and need not be separate devices. Specific examples of portable devices can include wearable devices, payment cards such as credit, debit, and prepaid cards, vehicles with remote communication capabilities, etc.

A “server computer” may include a powerful computer or cluster of computers. For example, the server computer can be a large mainframe, a minicomputer cluster, or a group of servers functioning as a unit. In one example, a server computer may be a database server coupled to a Web server. A server computer may comprise one or more computational apparatuses and may use any of a variety of computing structures, arrangements, and compilations for servicing the requests from one or more client computers.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a portable communication device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable communication device.

An “authorization request message” may be an electronic message that is sent to request authorization for a transaction. The authorization request message can be sent to a payment processing network and/or an issuer of a payment card. An authorization request message according to some embodiments may comply with ISO 8583, which is a standard for systems that exchange electronic transaction information associated with a payment made by a user using a payment device or payment account. The authorization request message may include information that can be used to identify an account. An authorization request message may also comprise additional data elements such as one or more of a service code, an expiration date, etc. An authorization request message may also comprise transaction information, such as any information associated with a current transaction, such as the transaction amount, merchant identifier, merchant location, etc., as well as any other information that may be utilized in determining whether to identify and/or authorize a transaction. The authorization request message may also include other information such as information that identifies the access device that generated the authorization request message, information about the location of the access device, etc.

An “authorization response message” may be an electronic message reply to an authorization request message. The authorization response message can be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant computer that indicates approval of the transaction. The code may serve as proof of authorization.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

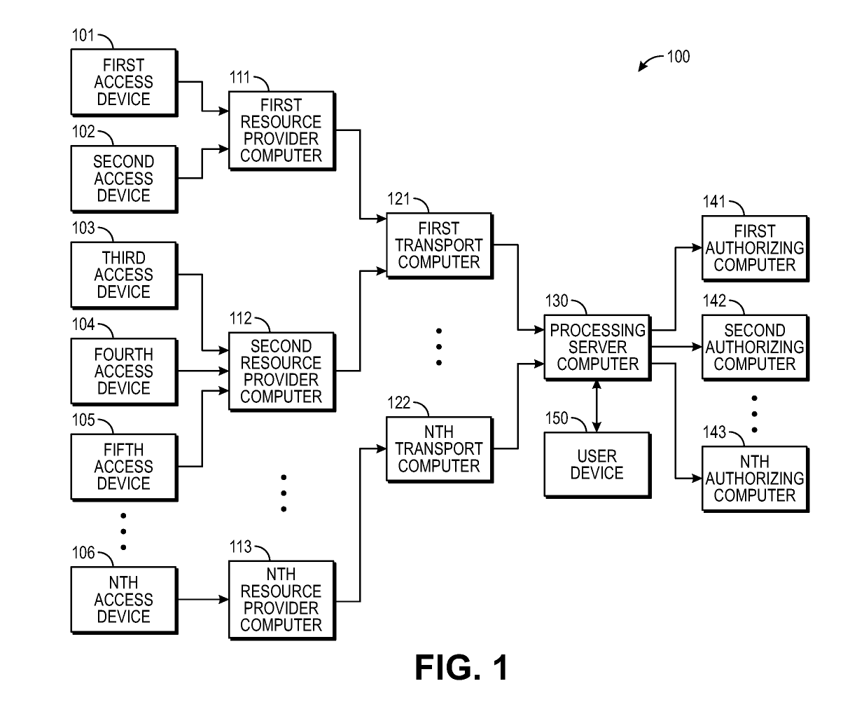

FIG. 1 shows a block diagram of a system according to embodiments of the invention. System 100 comprises of a plurality of access devices: first access device 101, second access device 102, third access device 103, fourth access device 104, fifth access device 105, and nth access device 106. System 100 may comprise any number of access devices (1 to n) which may each be used to conduct a plurality of transactions at a specific geographic location over time. For example, first access device 101 may be a POS terminal located in a store within the 94110 zip code of San Francisco, while second access device 102 may be a POS terminal located in a store within the 94103 zip code of San Francisco.

Each access device in the plurality of access devices may be used to conduct transactions with the same resource provider, a different resource provider within the same industry, or a different resource provider within a different industry. For example, third access device 103, fourth access device 104, and fifth access device 105 could all be POS terminals located at various Home Depot® locations in the San Francisco bay area, while first access device 101 and second access device 102 could be POS terminals used to conduct transactions with a home improvement store other than Home Depot® that may or may not be in the same metropolitan statistical area (MSA) or zip code as other access devices in the plurality of access devices. Meanwhile, nth access device 106 could be a POS terminal used to conduct transactions with a resource provider that would not be considered a home improvement store such as a grocery store, electronics supplier, restaurant, bar, cleaning service, etc.

System 100 also comprises a plurality of resource provider computers: first resource provider computer 111, second resource provider computer 112, and nth resource provider computer 113. The plurality of resource provider computers may comprise any number of computers belonging to any number of resource providers (1 to n). When an interaction such as a transaction is conducted at one of the access devices in the plurality of access devices, an authorization request message is generated by a resource provider server computer in communication with the access device comprising account information, a transaction amount, and a resource provider identifier. In other embodiments, the access devices themselves may generate the authorization request messages. Also, in some cases, a user may use a portable device to interact with an access device. For example, a consumer might purchase gardening supplies at a home improvement store in San Francisco for $89 and might insert his or her payment card into access device 101 to conduct the transaction. Access device 101 may then receive payment account information from the consumer's payment card and first resource provider computer 11 may generate an authorization request message comprising a product ID for Chase Freedom, a credit card number or primary account number (PAN) for the consumer's payment account, a transaction amount of $89, and a merchant ID for Lowe's® Home Improvement located at 491 Bayshore Boulevard, San Francisco, Calif. 94124. Meanwhile, other consumers may be conducting transactions at third access device 103 and fourth access device 104, which are located at a Home Depot® 1 mile away from access device 101, and second resource provider computer 112 may similarly generate authorization request messages in order to process those transactions.

Once an authorization request message has been generated by a resource provider computer in a transaction, the authorization request message may be sent to first transport computer 121 or nth transport computer 122. First transport computer 121 and nth transport computer may be transport computers of any number of acquirers (1 to n) that may process or transport a transaction to a processing entity. As used herein, an “acquirer” is typically a business entity that collects funds and processes transactions on behalf of a resource provider, e.g., a commercial bank that has a business relationship with a particular merchant. After receiving the authorization message, the transport computer (first transport computer 121 or nth transport computer 122) may forward the authorization request message to processing server computer 130.

Processing server computer 130 may be a server computer capable of processing data according to embodiments of the invention. Processing server computer 130 may be a server computer that processes transaction data in a transaction processing network. The transaction processing network may be a payment processing network such as VisaNet™. The processing network and any communication network that communicates with the processing network may use any other suitable wired or wireless network, including the Internet. The processing network may be adapted to process any type of transaction including ordinary debit or credit card transactions. Processing server computer 130 may gather transaction data from a plurality of authorization request messages from a plurality of resource provider computers in communication with a plurality of access devices at various geographic locations. Processing server computer 130 may comprise instructions for analyzing the transaction data from received authorization request messages, comparing the transaction data to resource provider data and geospatial data, and generating a dynamic visualization of the transaction data that may be manipulated according to a number of selected parameters. For example, processing server computer 130 may comprise software for generating a map containing indications of a specific merchant's market share within a specified geographic area according to the share (e.g. quantity or dollar amount) of transactions made with the specific merchant when compared to the total share of transactions made by other merchants in the same geographic area and of the same industry. Data relating to any comparisons made by the processing server computer 130 may be provided to the user device 150, which may have a graphical user interface for displaying data relating to the comparison.

Processing server computer 130 may authenticate the transaction data in the authorization request message and then forward the authorization request message to an authorizing computer such as first authorizing computer 141, second authorizing computer 142, or nth authorizing computer 143. For example, processing server computer may authenticate and conduct a risk analysis on the account information stored in the authorization request message and may then forward the authorization request message to an authorizing computer of the issuer of the account information such as first authorizing computer 141.

An “issuer” may be an entity that issues accounts and authorizes transactions made with said accounts and is typically a business entity (e.g., a bank) which issues a portable consumer device such as a credit or debit card to a consumer. Some entities can perform both issuer and acquirer functions. Embodiments of the invention encompass such single entity issuer-acquirers. An authorizing computer such as first authorizing computer 141, second authorizing computer 142, and nth authorizing computer 143 may authorize a transaction by, for example, querying a database for an account associated with account information received in an authorization request message, validating information and/or user details associated with the account, determining an availability of funds within the account for conducting the transaction, and evaluating a risk score or credit score associated with the account. The authorizing computer may then generate an authorization response message comprising an indication of approval or decline of the transaction which may be sent to the processing server computer 130, and then forwarded to the resource provider computer from which the authorization request message was generated via the appropriate transport computer (i.e. acquirer).

At the end of the day, or at some later point in time, a clearing and settlement process may take place and the appropriate allocation of funds may be facilitated between the involved parties. According to embodiments of the invention, several transactions involving system 100 may be processed by processing server computer 130, and a specific resource provider may analyze data from system 100 to determine their performance according to specified parameters such as share of transactions in a specified geographic location with respect to similar resource providers.

It should be noted, that each of the computers shown in FIG. 1 can be a powerful computer or cluster of computers. For example, a “computer” can refer to a server computer and can be a large mainframe, a minicomputer cluster, or a group of servers functioning as a unit. In one example, the server computer may be a database server coupled to a web server. The server computer may also comprise a processor, and a computer readable medium.

For simplicity of illustration, a specific number of components is shown in FIG. 1. However, it is understood that in other embodiments of the invention, there can be many more components or fewer components.

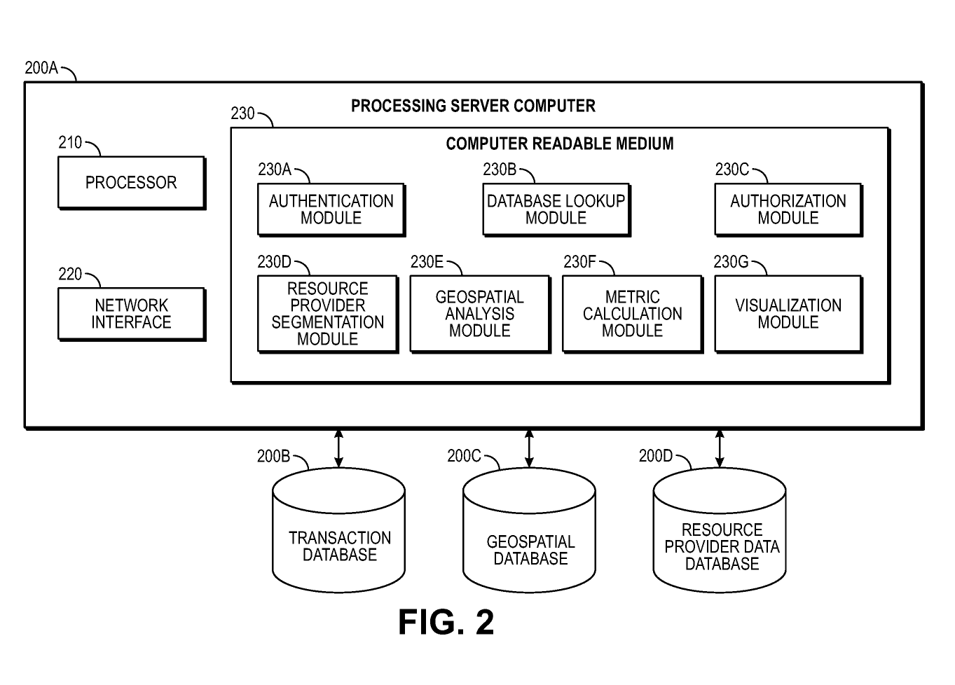

FIG. 2 shows an exemplary processing server computer according to embodiments of the invention. Processing server computer 200A may comprise processor 210 for executing instructions for carrying out a method according to embodiments of the invention. Processing server computer 200A may further comprise network interface 220 that may allow processing server computer 200A to send and receive messages communicated in a processing network involving interactions with the entities of system 100 shown in FIG. 1.

According to embodiments of the invention, processing server computer 200A may comprise computer readable medium 230 that may store code or instructions that may be executed by processor 210 such as instructions for dynamically assessing performance according to activity within a specific geographical area in the manner described herein. Exemplary computer readable media may include one or more memory chips, disk drives, etc.

Computer readable medium 230 may comprise authentication module 230A for authenticating transaction information contained in an authorization request message such as authenticating payment account information and assessing a risk score. Computer readable medium 230 may also comprise database lookup module 230B for locating a database and retrieving data, and may also comprise authorization module 230C for formatting and processing authorization request messages.

Processing server computer 200A may gather transaction data from a plurality of authorization request messages and may store the transaction data in transaction database 200B. Processing server computer 200A may further access geospatial database 200C storing data about geographic locations and their locations relative to each other. For example, geospatial database 200C may store geographic coordinates that may be linked to street addresses, zip codes, or other identifiers and may use the geographic coordinates to calculate the difference between two locations or areas (e.g. the address 491 Bayshore Boulevard, San Francisco, Calif. 94124 is 1.4 miles away from the zip code 94110). Processing server computer 200A may also access resource provider data database 200D storing data about a plurality of resource providers such as their store locations, industry, volume of transactions, market share, or any other data determined using any of the modules of computer readable medium 230 or extracted from some other remote database accessible by processing server computer 200A.

Processing server computer 200A may comprise resource provider segmentation module 230D for categorizing resource provider identifiers linked to transactions in transaction database 200B into specific segments and storing a record of the categorization and segments in resource provider data database 200D. For example, resource provider segmentation module 230D may comprise code for instructing processing server computer 200A to categorize all transactions linked to resource provider identifiers for Home Depot® and Lowe's® Home Improvement into a segment identified as “Home Improvement” in resource provider data database 200D.

Processing server computer 200A may comprise geospatial analysis module 230D for comparing data between transaction database 200B, geospatial database 200C, and resource provider data database 200D to determine transactions that have occurred or are occurring in relation to a specified geographical area. For example, geospatial analysis module 230E may comprise code that instructs processing server computer 200A to identify a set of transactions associated with the merchant identifier Lowe's® Home Improvement at 491 Bayshore Boulevard, San Francisco, Calif. in transaction database 200B and identify that the location of the merchant identifier is “ZIP code=94124.” Geospatial analysis module 230E may then query geospatial database 200C for “ZIP code=94124” and data associated with “ZIP code=94124” to determine geographic coordinates and/or addresses that are within a 10 mile radius of the zip code 94124. Geospatial analysis module may then compare the determined geographic coordinates and/or addresses that are within a 10 mile radius of the zip code 94124 to data in resource provider data database 200D to determine resource providers that have locations that are within the list of determined geographic coordinates and/or addresses and that also belong to the segment “Home Improvement.” Geospatial analysis module 230E may then instruct processing server computer 200A to query transaction database 200B for all transactions linked to resource provider identifiers for the determined resource providers within the determined geographic coordinates and/or addresses and of the same segment. Geospatial analysis module database 200B may then retrieve the queried transactions from transaction database 200B, and metric calculation module 230F may perform a number of calculations using the retrieved transactions. Thus, geospatial analysis module 230E is able to receive a first set of transactions associated with a resource provider, and may then query and retrieve a second set of transactions that are associated with other resource providers that are of the same segment and are within a specified geographical distance or area. The first and second set of transactions may be used as inputs to metric calculation module 230F, which may use the sets of transactions to calculate one or more performance metrics.

Processing server computer 200A may comprise metric calculation module 230F for calculating performance metrics from sets of transaction data according to embodiments of the invention. For example, processing server computer 200A may receive a set of transactions which are within 10 miles of the zip code 94124 and belong to the segment or industry “Home Improvement” and metric calculation module 230F may calculate “share of total spend/transactions” for Lowe's® Home Improvement relative to all home improvement stores in the area by dividing the total dollar amount spent at Lowe's® Home Improvement at 491 Bayshore Boulevard, San Francisco, Calif. 94124 by the total dollar amount spent at all home improvement stores within 10 miles of the zip code 94124. Any number of performance metrics for a given resource provider and/or client can be calculated by metric calculation module 230F including number of cards that made a transaction with client/total number of cards that made a transaction with client and peers (share of cards), total spend/transactions in a particular time period divided by number of active cards in the same time period (Spend/transactions per card), absolute difference in market share over previous year (percentage point change vs percentage change), and/or total spend in a particular time period divided by the number of transactions in the same time period (average ticket size).

Metric calculation module 230F may also calculate indexed metrics which show the ratio of a metric compared to the industry. For example, a ratio of 1.05× for a metric means that the client is 5% higher than the industry on that metric. According to embodiments of the invention, metric calculation module 230F may calculate metrics to include a client's other stores in a calculation (client market share) or to exclude a client's other stores in a calculation (store market share). For example, a client market share calculation may take into account all three Home Depot® stores in San Francisco, Calif. to determine that Home Depot® has a 50% market share compared to all home improvement stores in San Francisco, while a store market share calculation may only take into account one specified Home Depot® store to determine that the specified Home Depot® store has 15% market share compared to all home improvement stores in San Francisco. The toggling between these two different types of calculations may be referred to as “ZIP Market Share Type.” The calculated performance metrics output by metric calculation module 230F may be used by visualization module 230G to display a dynamic visualization or dashboard.

Processing server computer 200A may comprise visualization module 230G for receiving user inputs and generating a visualization of specified parameters and calculated performance metrics to be displayed on a user device. For example, visualization module 230G may comprise code for instructing processing server computer 200A to display on a user's computer monitor a map of the San Francisco bay area along with options for choosing a specific performance metric to be calculated (e.g. share of total spend/transactions) along with specified parameters such as zip codes and ZIP market share type. Processing server computer 200A may then receive user selections as inputs to be forwarded to geospatial analysis module 230E and metric calculation module 230F, and visualization module 230G may indicate the output of metric calculation module 230F by displaying markers of various colors and sizes representing various levels of market share.

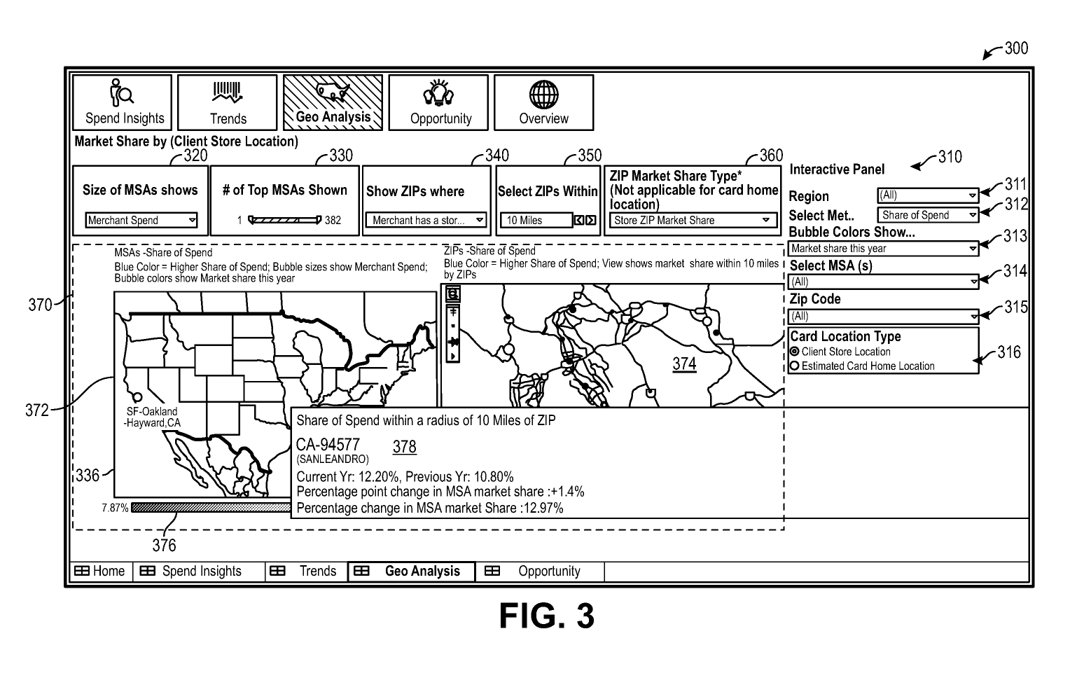

FIG. 3 shows an example of a user interface or dashboard according to an embodiment of the invention. User interface 300 may be a market share dashboard that a client or merchant may utilize to determine their market share in a given MSA or zip code. According to embodiments of the invention, when a user uses user interface 300 to select specific parameters and metrics, the selections are sent as commands to processing server computer 200A of FIG. 2 and are passed as inputs to geospatial analysis module 230E, metric calculation module 230F, and visualization module 230G of FIG. 2 so that processing server computer 200A may retrieve the proper data and process the retrieved data in the desired manner for display to the user.

User interface 300 may comprise interactive panel 310 which may be a set of drop-down menus and/or user-selectable options that allow a user to define parameters such as region 311 (e.g. north, south, east, or west United States), selected metric 312 (e.g. share of spend/transactions, share of cards, percentage point change vs percentage, etc.), significance of output indicator color 313 (e.g. blue indicators may signify high market share while red may signify low market share), selected MSA 314 (San Francisco bay area MSA, Seattle MSA, all MSAs, etc.), selected zip code 315, and card location type 316. Card location type may either be “client store location” meaning the outputted market share may be displayed based on location of client and peer stores, or may be “card home location” meaning the outputted market share may be displayed based on the estimated home location of cardholders.

User interface 300 may further comprise options for controlling other output parameters such as significance of output indicator size 320 (e.g. larger indicators may signify higher client spend/transactions, while smaller indicators may signify lower client spend/transactions), # of top MSAs shown 330 (e.g. show top 1 MSA, top 10 MSAs, top 382 MSAs etc.), condition for ZIPs shown 340 (e.g. only show where merchant has a store), specified geographical area 350 (e.g. within 10 miles of zip code 94110), and ZIP market share type 360.

User interface 300 may comprise an output display 370 which may be a map overlaid with indicators of varying colors and sizes communicating the client's market share according to the user's chosen parameters and metrics. Output display 370 may comprise MSA output display 372 displaying the output by MSA according to the parameters significance of output indicator size 320 and # of top MSA shown 330, and may also comprise ZIP output display 374 displaying the output by zip code according to the parameters condition for ZIPs shown 340, specified geographical area 350, and ZIP market share type 360.

User interface 300 may also comprise one or more color legends 376 showing the values represented by each indicator color for the indicators shown on MSA output display 372, ZIP output display 374, or both. User interface 300 may comprise output summary 378 summarizing the client's market share according to the selected parameters. For example, output summary 378 may state that the output represents the share of spend within a radius of 10 miles of the zip code 94577 and may also state the share of spend for the current year, the previous year, the percentage point change in MSA market share, the percentage change in MSA market share, and a list of ZIPs that are within 10 miles of 94577.

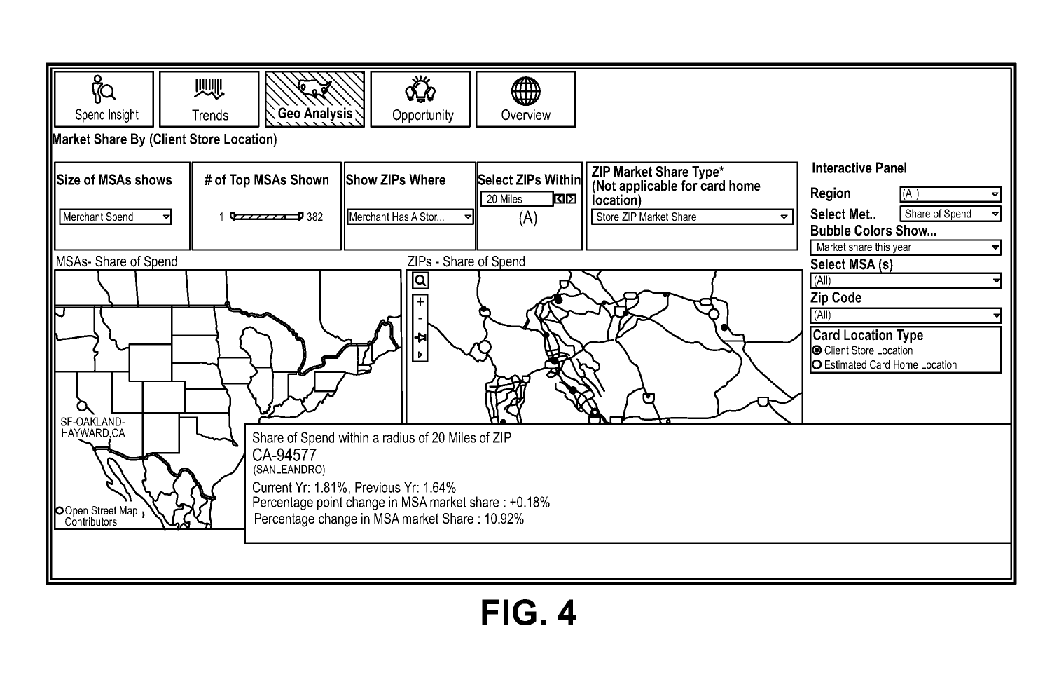

FIG. 4 illustrates an adjustment of a specified parameter according to an embodiment of the invention. Specifically, FIG. 4 shows how the output display 370 and output summary 378 of FIG. 3 change in response to the adjustment of specified geographical area 350. In FIG. 4, the specified geographical area (A) has been adjusted from “ZIPs within 10 miles of the client's ZIP code” to “ZIPs within 20 miles of the client's ZIP code.”

The adjustment in the specified parameters results in a request for an indication of market share, which is received by processing server computer 200A. The request comprises the specified parameters which are passed as inputs to geospatial analysis module 230E, metric calculation module 230F, and visualization module 230G of FIG. 2 so that processing server computer 200A may retrieve the proper data and process the retrieved data in the desired manner for display to the user. This results in a change in output as shown by the difference in output of FIG. 4 in comparison to output display 370 and output summary 378 of FIG. 3. For example, one can see that the current year share of spend shown in FIG. 3 is 12.20%, while the current year share of spend shown in FIG. 4 is 1.81%. This means that the specified client store has a 12.20% market share when considering all stores of the same market segment within 10 miles of the store's ZIP code, but only a 1.81% when considering all stores of the same market segment within 20 miles of the store's ZIP code.

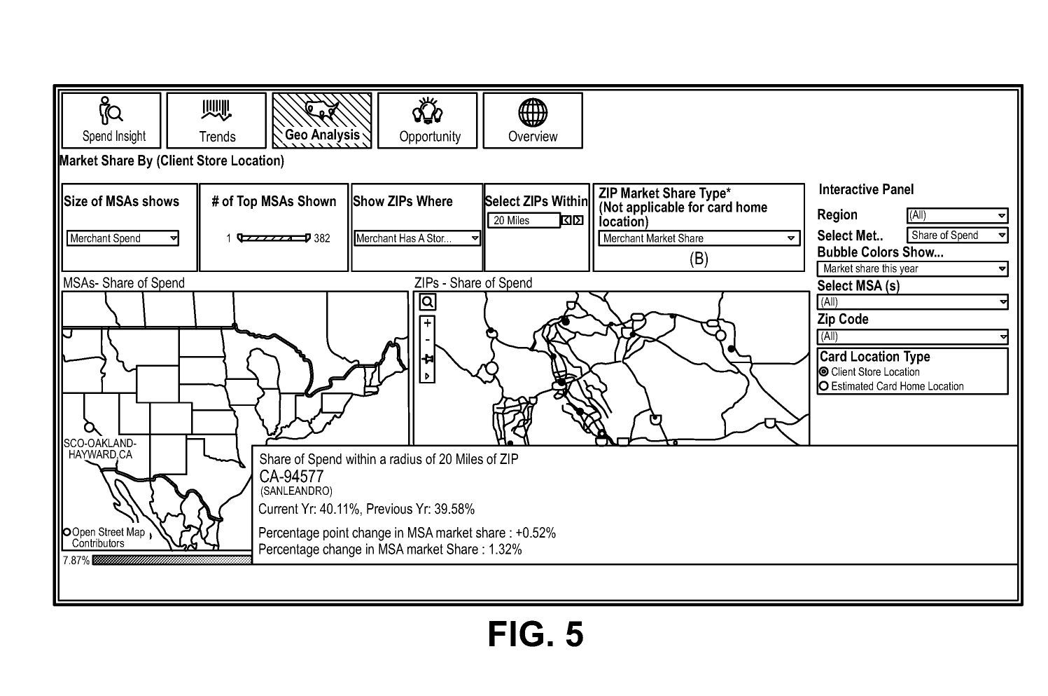

FIG. 5 illustrates a change in performance metric type according to an embodiment of the invention. Specifically, FIG. 5 shows how the output of the user dashboard as shown in FIG. 4 changes when changing the performance metric type from “store market share” to “merchant market share” (B). As previously described, “store market share” only considers a specific resource provider location when calculating metrics. For example, share of spend for Lowe's® Home Improvement at 491 Bayshore Boulevard, San Francisco, Calif. 94124 according to “store market share” would only consider one individual Lowe's® Home Improvement location that is specified and not any other Lowe's® Home Improvement store located at some other location within the specified geographical area. In other words, only transactions made at for Lowe's® Home Improvement at 491 Bayshore Boulevard, San Francisco, Calif. 94124 would be considered client transactions in the equation: Client's total spend per transactions divided by total spend per transactions in segment.

However, “merchant market share” considers all resource provider locations into account when calculating a performance metric. For example, share of spend for Lowe's® Home Improvement at 491 Bayshore Boulevard, San Francisco, Calif. 94124 according to “merchant market share” would consider all Lowe's® Home Improvement locations within the specified geographical area. In other words, all transactions made at any given Lowe's® Home Improvement within the area would be considered client transactions in the equation: Client's total spend per transactions divided by total spend per transactions in segment.

Looking at the difference in current year share of spend shown by FIG. 5 in comparison to current year share of spend shown by FIG. 4, one can see that current year share of spend according to “store market share” for the client shown is only 1.81%, while the current year share of spend according to “merchant market share” for the client shown is 40.11%. This would be expected as considering a larger number of stores when determining market share for a particular client would result in a larger market share of a given segment within a specified geographical area.

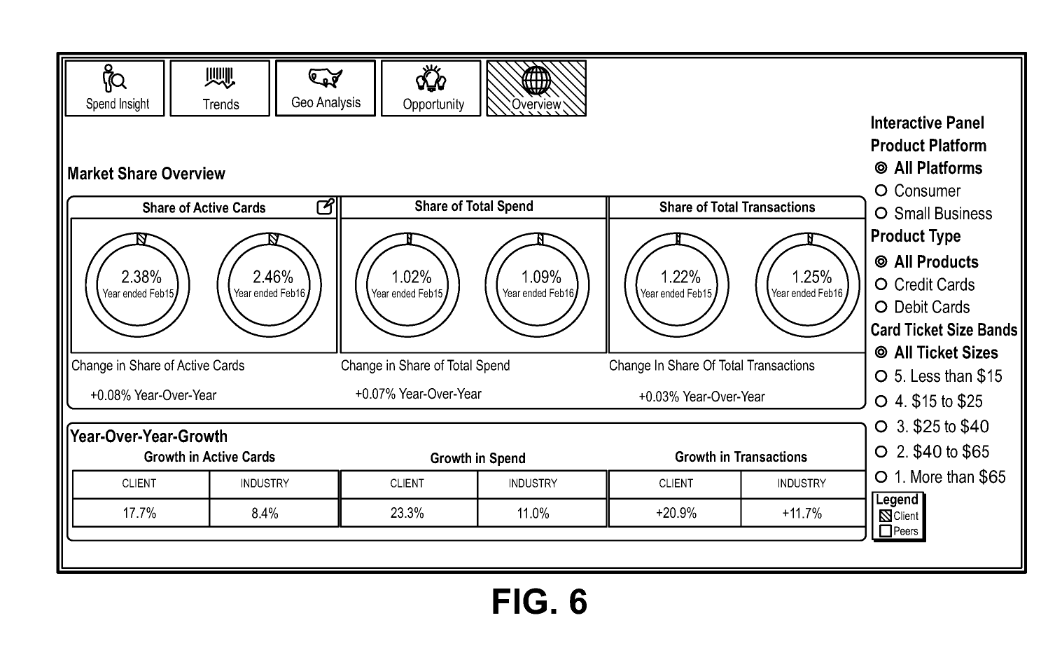

FIG. 6 shows an example of a performance metrics overview according to an embodiment of the invention. The performance metrics overview may be a selectable view summarizing a plurality of metrics calculated by processing server computer 200 (e.g. share of active cards, share of total spend, share of total transactions, etc.) in chart form and for two consecutive years. For example, the performance metrics may be shown in pie chart form in which client's market share according to each metric is expressed by the area of a colored section of the pie chart relative to the entire chart. The performance metrics overview may also show how a client has improved according to each metric in the plurality of metrics and the relative growth in these metrics by the client from one year to the next (i.e. “Year-over-year Growth”).

The performance metrics overview may also comprise of an interactive panel that allow a user to further constrain and/or define parameters used in calculating performance metrics. For example, the interactive panel may comprise selections for product platform (all, consumer, small business, etc.), product type (i.e. credit, debit, or all), and/or card ticket size brands (all, less than $15, $15 to $25, $25 to $40, etc.). These selections on the interactive panel may serve the purpose of adjusting parameters that are used by processing server computer 200 when calculating and displaying metrics, and may change the output shown by the performance metrics overview of FIG. 6. For example, a client's year-over-year growth for credit cards may be different from the client's year-over-year growth for debit cards, which would be reflected by the performance metrics overview after processing server computer 200 received the adjusted parameters and calculated the resulting metrics based on the adjusted parameters.

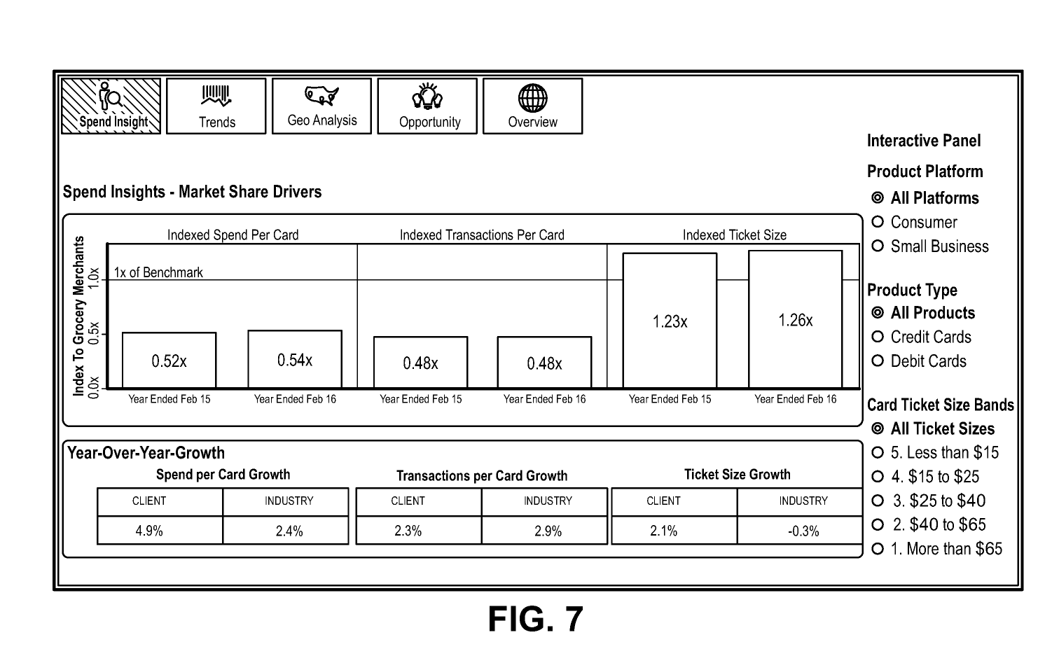

FIG. 7 shows an example of indexed metrics according to an embodiment of the invention. According to embodiments of the invention, performance metrics calculated by server computer 200 and defined by parameters selected by a user and/or client may be expressed indexed metrics that express a client's performance as a ratio relative to competing resource providers within the same segment and specified geographical area. These ratios may be expressed as bar graphs relative to a segment and/or industry benchmark. For example, a client's indexed ticket size may be 23% higher than the industry benchmark and may be expressed as a vertical bar that rises above the industry benchmark (1×) and may be indicated by the value 1.23×. The user dashboard as shown by FIG. 7 may also comprise of an interactive panel that allow a user to further constrain and/or define parameters used in calculating performance metrics.

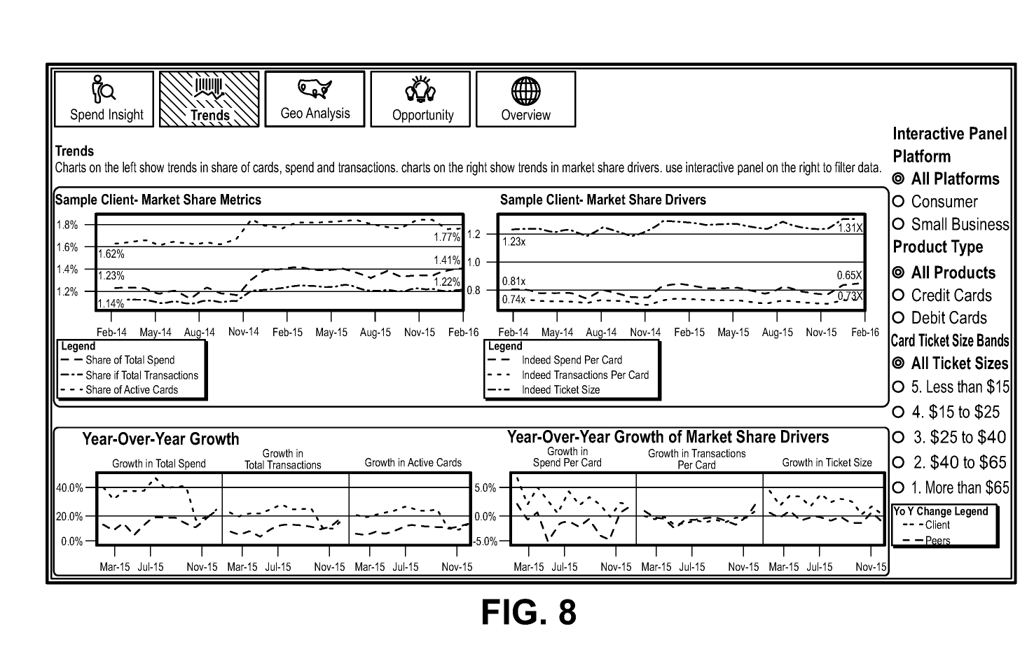

FIG. 8 shows an example of performance metrics calculated over time according to embodiments of the invention. Specifically, FIG. 8 shows performance metrics calculated continuously over a specified period of time and as expressed as trend lines. Each trend line may show a different performance metric calculation over the specified time period. For example, user dashboard as shown by FIG. 8 may comprise a first window showing a set of performance metrics (share of total spend, share of total transactions, share of active cards) as well as how each performance changes over time from February 2014 to February 2016, represented by three trend lines of varying color. The user dashboard may also comprise, for example, a second window showing a second set of performance metrics according to indexed metrics (indexed spend per card, indexed transactions per card, indexed ticket size), which may also be represented by three trend lines of varying color. The user dashboard as shown by FIG. 8 may also comprise of an interactive panel that allow a user to further constrain and/or define parameters used in calculating performance metrics.

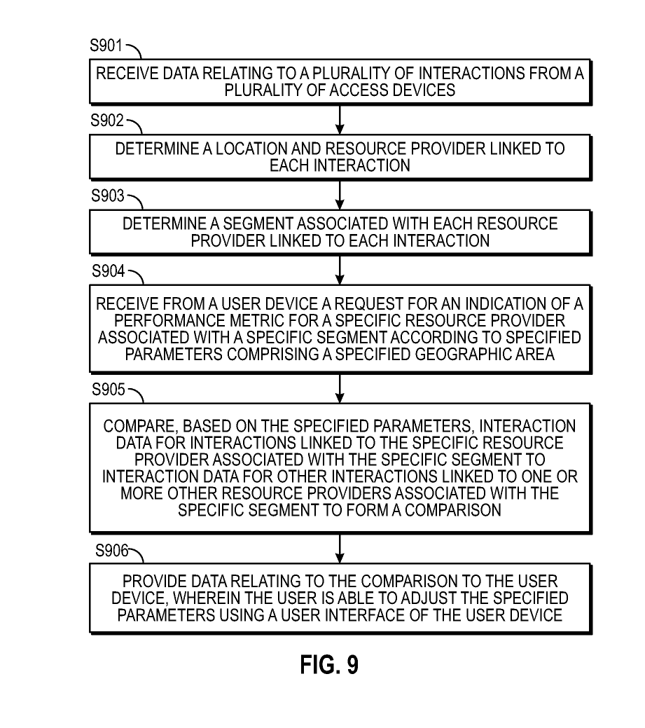

FIG. 9 shows a flowchart illustrating a method according to embodiments of the invention. It is understood that methods according to embodiments of the invention may include some, all, or any suitable combination of steps shown in FIG. 9. The method shown may be performed by a server computer such as processing server computer 130 of FIG. 1 and/or processing server computer 200A of FIG. 2.

In step S901, the server computer may receive data relating to a plurality of interactions from a plurality of access devices. For example, the server computer may receive data for transactions made at various home improvement stores, grocery stores, etc. across various cities and various zip codes.

In step S902, the server computer may determine a location and a resource provider linked to each interaction. For example, the server computer may determine that a transaction for $100 was made at Lowe's® Home Improvement at 491 Bayshore Blvd, San Francisco, Calif. 94124, a transaction for $80 was made at Home Depot® at Westlake Shopping Center, 303 Lake Merced Blvd, Daly City, Calif. 94015, etc, and may continue to make similar determinations for each transaction it receives and store a record of the determinations in a database for later reference.

In step S903, the server computer may determine a segment such as a market segment associated with each resource provider. For example, the server computer may determine that all transactions linked to Home Depot® and Lowe's® Home Improvement are associated with the market segment “Home Improvement” and may link those transactions in a database.

In step S904, the server computer may receive from a user device a request for an indication of a performance metric for a specific resource provider associated with a specific segment according to specified parameters comprising a specified geographic area. The request may comprise one or more specified parameters including a specified geographic area such as “within 10 miles of zip code 94110.” The specified parameters may be any number of selectable options provided by the user interface 300 of FIG. 3.

In step S905, the server computer may compare, based on the specified parameters in the request, interaction data for interactions linked to the specific resource provider to interaction data for other interactions linked to one or more other resource providers associated with the specific segment. For example, the server computer may compare transaction data linked to Lowe's® Home Improvement at 491 Bayshore Boulevard, San Francisco, Calif. 94124 to all transaction data linked to resource providers associated with the market segment “Home Improvement” that are within 10 miles of zip code 94110 by dividing the total spend/transactions made at Lowe's® Home Improvement at 491 Bayshore Boulevard, San Francisco, Calif. 94124 by the total spend/transactions made at all home improvement stores within 10 miles of zip code 94110.

In step S906, the server computer may provide data relating to the comparison to the user device, wherein the user is able to adjust the specified parameters using a user interface of the user device. For example, the server computer may display a map of a specified geographical area overlaid with indicators of varying sizes and colors which communicate a quantitative measure of market share. Furthermore, the map may be accompanied by a legend which may indicate, for example, that blue indicators represent a high share of spend approaching a maximum market share of 68.14% and that red indicators represent a low share of spend approaching a minimum market share of 7.87%.

Furthermore, in embodiments, an action may be taken based on the comparison. If a given performance metric for a particular location is low, then the situation can be mitigated through an automated response. For example, if a merchant has a low market share in a particular zip code, a signal can be sent to a marketing server and/or digital advertising system to increase marketing activity directed at the particular zip code.

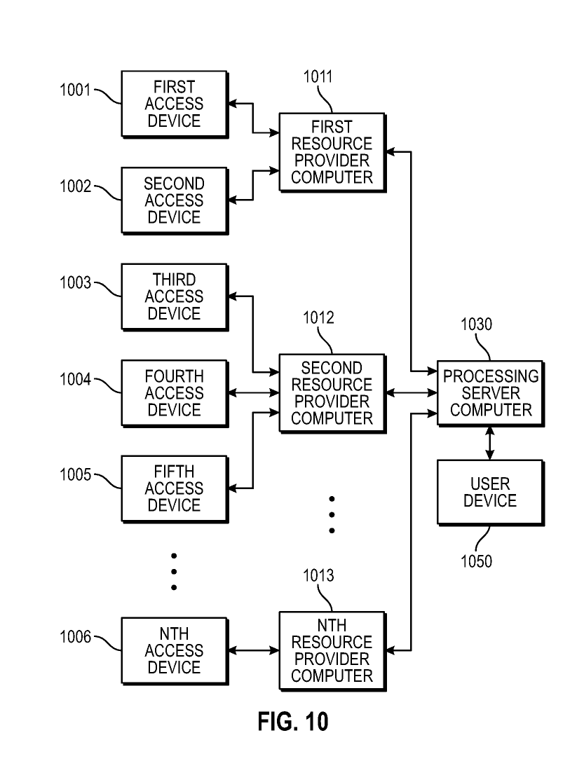

FIG. 10 shows a block diagram of another system according to another embodiment of the invention. Like the system illustrated in FIG. 1, first, second, third, fourth, fifth, and nth access devices 1001, 1002, 1003, 1004, 1005, and 1006, first, second, and nth resource provider computers 1011, 1012, 1013, and a processing computer 1030 are illustrated. In this system embodiment, however, transport computers and authorizing entity computers are not illustrated. In this example, the first, second and nth resource provider computers 1011, 1012, 1013 may correspond to content providers of digital content. The processing server computer 1030 may be a central point and may communicate with the resource provider computers 1011, 1012, 1013.

Similar to the examples described with respect to FIGS. 1-9, the processing server computer 130 can receive data relating to a number of interactions performed by the various access devices 1001, 1002, 1003, 1004, 1005, 1006. Locations associated with each interaction can be obtained by the resource provider computers 1011, 1012, 1013, and may be transmitted to the processing server computer 1030. This data may then be stored at the processing server computer 1030.

At some point, a user device 1050 can generate and transmit a request to the processing server computer 1030 to request information pertaining to a specific performance metric (e.g., content consumption) for a particular segment (e.g., sporting events) within a particular geographic area (e.g., a particular zip code). The processing server computer 1030 may then use the data in the request and may compare it to the performance of access devices operated by other resource providers in that locale. This comparison may be provided to the user device 1050 and may be displayed to them on a user interface. The resource provider associated with the user device 1050 may then take some sort of automated or manual corrective action in response to the comparison data that is received. As an example, if an entertainment provider aimed at a particular demographic and area (e.g. single content viewers between the ages of 22-40 in New York City), is performing below average in terms of number and duration of content views, then an increase in programmatic advertisement purchases directed to the particular demographic may be initiated.

The software components or functions described in this application, may be implemented as software code to be executed by one or more processors using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may also reside on or within a single computational apparatus, and may be present on or within different computational apparatuses within a system or network.

Some embodiments of the present invention can be implemented in the form of control logic in software or hardware or a combination of both. The control logic may be stored in an information storage medium as a plurality of instructions adapted to direct an information processing device to perform a set of steps disclosed in an embodiment of the present invention. Based on the disclosure and teachings provided herein, a person of ordinary skill in the art will appreciate other ways and/or methods to implement the present invention.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

All patents, patent applications, publications, and descriptions mentioned above are herein incorporated by reference in their entirety for all purposes. None is admitted to be prior art.

What is claimed is:

1. A method comprising:
receiving, by a processing server computer, from a plurality of access devices, data relating to a plurality of interactions;
determining, by the processing server computer, a location and a resource provider linked to each interaction;
determining, by the processing server computer, a segment associated with each resource provider linked to each interaction;
receiving, by the processing server computer, from a user device operated by a user, a request for an indication of a performance metric for a specific resource provider associated with a specific segment according to one or more specified parameters comprising a specified geographical area;
comparing, by the processing server computer, based on the one or more specified parameters, interaction data for interactions linked to the specific resource provider associated with the specific segment to interaction data for other interactions linked to one or more other resource providers associated with the specific segment to form a comparison; and
providing, by the processing server computer, data relating to the comparison to the user device, wherein the user is able to adjust the specified parameters using a user interface of the user device.

2. The method of claim 1, wherein the performance metric relates to a consumption of a resource.

3. The method of claim 2, wherein the resource comprises digital data.

4. The method of claim 1 further comprising:
receiving, by the processing server computer, a specified range of time; and
providing, by the processing server computer, data relating to a visualization of change in the performance metric over the specified range of time.

5. The method of claim 1, wherein the access devices provide the interaction data to one or more resource provider computers before being received by the processing server computer.

6. The method of claim 1, wherein the performance metric is data consumption.

7. A computer comprising:
a processor; and
a computer readable medium, the computer readable medium comprising code, executable by the processor, for implementing a method comprising
receiving from a plurality of access devices, data relating to a plurality of interactions,
determining a location and a resource provider linked to each interaction,
determining a segment associated with each resource provider linked to each interaction,
receiving from a user device operated by a user, a request for an indication of a performance metric for a specific resource provider associated with a specific segment according to one or more specified parameters comprising a specified geographical area,
comparing based on the one or more specified parameters, interaction data for interactions linked to the specific resource provider associated with the specific segment to interaction data for other interactions linked to one or more other resource providers associated with the specific segment to form a comparison, and
providing, by the processing server computer, data relating to the comparison to the user device, wherein the user is able to adjust the specified parameters using a user interface of the user device.

8. The computer of claim 7, wherein the performance metric relates to a consumption of a resource.

9. The computer of claim 8, wherein the resource comprises digital data.

10. The computer of claim 7, wherein the method further comprises:
receiving, by the processing server computer, a specified range of time; and
displaying, by the processing server computer, a visualization of change in the performance metric over the specified range of time

11. The computer of claim 7, wherein the access devices provide the interaction data to one or more resource provider computers before being received by the processing server computer.

12. The computer of claim 7, wherein the performance metric is data consumption.

13. A method performed by a user device, the method comprising:
providing, by a user device, a request to a processing server computer, for an indication of a performance metric for a specific resource provider associated with a specific segment according to one or more specified parameters comprising a specified geographical area, wherein the processing server computer compares, based on the specified parameters, interaction data for interactions linked to the specific resource provider associated with the specific segment to interaction data for other interactions linked to one or more other resource providers associated with the specific segment to form a comparison, and provides data relating to the comparison to the user device; and
receiving, by the user device, the data relating to the comparison, wherein the user is able to adjust the one or more specified parameters using a user interface of the user device.

14. The method of claim 13, further comprising:
adjusting, by the user device, the specified parameters using a user interface.

15. The method of claim 13, wherein the user device is a mobile device.
